(19) United States
(12) Patent Application Publication
(10) Pub. No.: US 2024/0282084 A1
(43) Pub. Date: Aug. 22, 2024

(54) IMAGE DATA PROCESSING APPARATUS AND METHOD

(71) Applicant: CANON MEDICAL SYSTEMS CORPORATION, Tochigi (JP)

(72) Inventors: Francesco Dalla SERRA, Bonnington Bond Edinburgh (GB); Alison O'NEIL, Bonnington Bond Edinburgh (GB); Chaoyang WANG, Bonnington Bond Edinburgh (GB)

(73) Assignee: CANON MEDICAL SYSTEMS CORPORATION, Tochigi (JP)

(21) Appl. No.: 18/581,231

(22) Filed: Feb. 19, 2024

Related U.S. Application Data
(60) Provisional application No. 63/486,352, filed on Feb. 22, 2023.

(51) Int. Cl. G06V 10/774; G06T 7/00; G06V 10/22; G06V 10/80; G06V 10/82; G06V 20/70

(52) U.S. Cl. CPC G06V 10/774; G06T 7/0016; G06V 10/235; G06V 10/806; G06V 10/82; G06V 20/70; G06T 2207/20081; G06T 2207/20084; G06V 2201/03

(57) ABSTRACT

A data processing apparatus configured to train an image analysis model to perform a task relating to input data which includes at least image data, wherein the data processing apparatus comprises processing circuitry configured to:
receive the input data;
generate image tokens for inputting to the image analysis model by applying a visual extractor model that is trained to identify an anatomical region included in the image data which is comprised in the input data and to determine a label relating to a pre-determined sub-task relating to said anatomical region; and
train the image analysis model by inputting at least the image tokens.

### CROSS-REFERENCE TO RELATED APPLICATIONS

The present application is based on and claims priority to provisional Application No. 63/486,352, filed on Feb. 22, 2023, the entire contents of which are incorporated herein by reference.

### FIELD

Embodiments described herein relate generally to a method and apparatus for processing image data, for example for using a first model to produce image tokens and inputting said image tokens into a second model to perform an imaging task.

### BACKGROUND

Transformer models are a family of deep learning models based on the use of multi-headed self-attention mechanisms. Transformer models may be used for, for example, image classification, visual question answering, image captioning, and/or automated reporting.

Input to a transformer often comprise image tokens from a visual extractor, position embeddings providing a vector representation of an index in an input sequence, and segment embeddings providing a vector representation of an input modality. Input data for transformer models for medical imaging may for example comprise either sequences of global features, such as feature maps from an encoder model, or patches, such as a grid of images. Both of these representations ignore the spatial structure of the input.

Depending on a choice of visual extractor, different image token representations may be obtained. The image token representations may be representative of a full image or of separate objects in an image.

In some circumstances, an output of a transformer model applied to an image may lack accuracy. In some circumstances, a transformer model applied to an image may not be easily interpretable. In some circumstances, an output of a transformer model may not have the required accuracy for clinical use.

In particular, where a subsequent task is image captioning, the description of anatomical location is often inaccurate in automatically generated reports. Masking out input tokens to observe the impact in output, it is usually found that that there is only a weak spatial correspondence between input and output.

### SUMMARY

In a first aspect, there is provided a data processing apparatus configured to train an image analysis model to perform a task relating to input data which includes at least image data, wherein the data processing apparatus comprises processing circuitry configured to: receive image data; generate at least image tokens for inputting to the image analysis model by applying a visual extractor model that is trained to identify an anatomical region included in the image data and to determine a label relating to a pre-determined sub-task relating to said anatomical region; and train the image analysis model by inputting at least the image tokens.

A token is a single unit of the input sequence. This can represent a single word or sub-word (textual tokens) or an image patch or an anatomy (visual tokens).

The task for which the image analysis model is trained may comprise image classification, visual question answering, image captioning and automated reporting.

The image analysis model may comprise a transformer model. The transformer model may comprise a BERT (Bidirectional Encoder Representations from Transformers) model.

The image analysis model may comprise any model that is configured to take an input that comprises a sequence. The image model may comprise a recurrent model. The image analysis model may comprise a convolutional neural network (CNN).

The visual extractor model may comprise a convolutional neural network (CNN). The visual extractor model may comprise a Faster R-CNN (Region-based convolutional neural network) model.

The input data may comprise multi-modal data. The visual extractor may be applied to the multi-modal data. The multi-modal data may comprise a first data type comprising image data and a second, different data type. The second data type may comprise text data. The second data type may comprise structured clinical data. The second data type may comprise genetics data.

The input data may further comprise text data. The image analysis model may be applied to the text data. The image tokens may be concatenated together. Tokens representative of the text data may be concatenated with the image tokens.

The text data may comprise patient history data. The text data may comprise scan information. The text data may comprise information relating to a question to be answered. The text data may comprise information relating to the task to be performed. The text data may comprise at least part of a report, for example a radiology report. The text data may comprise at least part of a previous report, for example a previous radiology report.

The pre-determined sub-task may be related to the task performed by the image analysis model. The pre-determined sub-task may comprise a part of the task performed by the image analysis model.

The pre-determined sub-task may be a task for obtaining a finding in respect of the anatomical region. The pre-determined sub-task may be a task for determining presence of a finding in the anatomical region. The pre-determined sub-task may be a task for determining absence of a finding in the anatomical region.

The finding may comprise at least one of: a condition, a pathology, a status, a change, a degeneration. The finding may comprise a radiology finding.

The training of the image analysis model may comprise inputting ground truth data comprising results of the task to be performed.

The results may comprise a text output. The text output may comprise a radiology report.

The identifying of the anatomical region may comprise determining a bounding box for the anatomical region. The visual extractor model may identify a plurality of anatomical regions. The identifying of the plurality of anatomical regions may comprise determining a respective bounding box for each of the plurality of anatomical regions.

The plurality of anatomical regions may be of different generational layers of an ontology. The training of the image analysis model may comprise masking out at least one generational layer of the ontology.

The generating of the image tokens may comprise concatenating a feature representation of the anatomical region with a global image feature representation.

The visual extractor model may determine the label for the pre-determined sub-task for each of a cluster of anatomical regions.

The training of the image analysis model may comprise masking out the cluster of anatomical regions relating to said pre-determined sub-task.

The visual extractor model may determine the label for the pre-determined sub-task for each of a plurality of anatomical regions.

The training of the image analysis model may further comprise inputting ground truth data comprising results of the task to be performed. The results may comprise text data comprising a plurality of sentences. The training of the image analysis model may comprise deleting at least one sentence of the plurality of sentences relating to said pre-determined sub-task. The training of the image analysis method may further comprise masking out a cluster of anatomical regions corresponding to said deleted at least one sentence.

The image data may comprise data from two scans of a subject. The two scans may comprise a current scan and a prior scan. Corresponding image tokens from the current scan and prior scan may be paired when inputting the image tokens to the image analysis model. The pre-determined sub-task may be to predict a change of an attribute of a finding between the prior scan and the current scan, or the absence of a change of said attribute. The attribute of the finding may comprise presence of the finding. The attribute of the finding may comprise absence of the finding.

In a further aspect, which may be provided independently, there is provided a data processing method for training an image analysis model to perform a task relating to input data which includes at least image data, the method comprising: receiving image data; generating image tokens for inputting to the image analysis model by applying a visual extractor model that is trained to identify an anatomical region included in the image data and to determine a label relating to a pre-determined sub-task relating to said anatomical region; and training the image analysis model by inputting the image tokens.

In a further aspect, which is provided independently, there is provided data processing apparatus for applying an image analysis model that is trained to perform a task relating to input data which includes at least image data, the data processing apparatus comprising processing circuitry configured to: receive image data associated with a subject; generate image tokens for inputting to the image analysis model by applying a visual extractor model that is trained to identify an anatomical region included in the image data and to determine a label relating to a pre-determined sub-task relating to said anatomical region; and apply the image analysis model to said image tokens, wherein the image analysis model performs said task and generates an output relating to the subject.

The task for which the image analysis model is trained may comprise image classification. The task for which the image analysis model is trained may comprise visual question answering. The task for which the image analysis model is trained may comprise image captioning. The task for which the image analysis model is trained may comprise automated reporting.

The image analysis model may comprise a transformer model. The transformer model may comprise a BERT (Bidirectional Encoder Representations from Transformers) model.

The image analysis model may comprise any model that is configured to take an input that comprises a sequence. The image model may comprise a recurrent model. The image analysis model may comprise a convolutional neural network (CNN).

The visual extractor model may comprise a convolutional neural network (CNN). The visual extractor model may comprise a Faster R-CNN (Region-based convolutional neural network) model.

The input data may comprise multi-modal data. The visual extractor model may be applied to the multi-modal data. The multi-modal data may comprise a first data type comprising image data and a second, different data type. The second data type may comprise text data. The second data type may comprise structured clinical data. The second data type may comprise genetics data.

The input data may further comprise text data. The image analysis model may be applied to the text data. The image tokens may be concatenated together. Tokens representative of the text data may be concatenated with the image tokens.

The text data may comprise patient history data. The text data may comprise scan information. The text data may comprise information relating to a question to be answered. The text data may comprise information relating to the task to be performed. The text data may comprise at least part of a report, for example a radiology report. The text data may comprise at least part of a previous report, for example a previous radiology report.

The pre-determined sub-task may be related to the task performed by the image analysis model. The pre-determined sub-task may comprise a part of the task performed by the image analysis model.

The pre-determined sub-task may be a task for detecting a finding in the anatomical region. The pre-determined sub-task may be a task for determining presence of a finding in the anatomical region. The pre-determined sub-task may be a task for determining absence of a finding in the anatomical region.

The finding may comprise at least one of: a condition, a pathology, a status, a change, a degeneration. The finding may comprise a radiology finding.

The output may comprise a text output. The output may comprise a radiology report.

The identifying of the anatomical region may comprise determining a bounding box for the anatomical region. The visual extractor model may identify a plurality of anatomical regions. The identifying of the plurality of anatomical regions may comprise determining a respective bounding box for each of the plurality of anatomical regions.

The generating of the image tokens may comprise concatenating a feature representation of the anatomical region with a global image feature representation. The visual extractor model may determine the label for the pre-determined sub-task for each of a cluster of anatomical regions.

The processing circuitry may be further configured to receive an input from a user that is indicative of a selection of a sub-set of the plurality of anatomical regions. The processing circuitry may be further configured to limit the image tokens that are used by the image analysis model in accordance with the selection.

The image data may comprise data from two scans of the subject. The two scans may comprise a current scan and a prior scan. Corresponding image tokens from the current scan and prior scan may be paired when inputting the image tokens to the image analysis model.

The task may comprise visual question answering. The processing circuitry may be further configured to receive a selection of a sub-set of anatomical regions from a user and to perform the task with reference to said sub-set of anatomical regions.

In a further aspect, which may be provided independently, there is provided a method for applying an image analysis model that is trained to perform a task relating to input data which includes at least image data, the method comprising: receiving image data associated with a subject; generating image tokens for inputting to the image analysis model by applying a visual extractor model that is trained to identify an anatomical region included in the image data and to determine a label relating to a pre-determined sub-task relating to said anatomical region; and applying the image analysis model to said image tokens, wherein the image analysis model performs said task and generates an output relating to the subject.

In a further aspect, which may be provided independently, there is provided a training method of transformers model which processes a task relating to multi-modal data at least including image data comprising a following steps: receiving image data, generating image tokens for inputting to the transformers model by training an anatomical region included in the image data and a label relating to predetermined sub-task relating the anatomical region, training the transformers model by inputting the image tokens.

The predetermined sub-task may be a task for finding detection in the anatomical region. The multi-modal data may further include text data.

In another aspect, which may be provided independently, there is provided a method for task-aware atlas-grounded tokens, comprising:
a) a set of medical images annotated with anatomical regions and the target task ground truth for those regions;
b) a visual extractor model that can be trained to extract anatomical region features and to perform a helper task for the target task for the same feature representation, in order to obtain task-aware atlas-grounded tokens; and
c) an image analysis model that can take a sequence of image feature tokens as input.

Method b) may be a CNN network, for instance Faster R-CNN. Method b introduces supervision at the point of token extraction. Method c) may be a transformer network, for instance a BERT model.

A global image feature representation may be concatenated with each local anatomical feature representation to form the tokens.

The anatomical regions may be organised as an ontology and different generational layers of the ontology may be masked out during training to increase model prediction robustness (anatomical hierarchical layer dropout).

The target task may be medical image classification and finding presence/absence classification may be set as the helper task.

A cluster of containing anatomical regions may be defined for each Finding, and Finding clusters may be randomly masked out during training alongside adjustment of the corresponding Finding class (augmentation method).

The target task may be medical image captioning and finding presence/absence classification may be set as the helper task.

A cluster of containing anatomical regions may be defined for each set of Findings that are described in each sentence of the target report for a given image, and sentence clusters may be randomly masked out during training alongside deletion of the corresponding sentence (augmentation method).

At test time the clinical user may be provided with the option to choose which predefined anatomical regions should be included as the input.

Task-aware anatomical-grounded tokens may be extracted from 2 scans of the same patient comprising a current scan and a prior scan, and corresponding tokens may be paired at the input (allows comparative sentences).

Task-aware anatomical-grounded tokens may be extracted simultaneously from 2 scans of the same patient comprising a current scan and a prior scan, and the helper task may be to predict the change between the scans in presence/absence or other attributes of Findings.

The target task may be visual question answering and the clinical user may be provided with the option to frame their question with respect to predefined anatomical regions.

Features in one aspect or embodiment may be combined with features in any other aspect or embodiment in any appropriate combination. For example, apparatus features may be provided as method features and vice versa.

### BRIEF DESCRIPTION OF THE DRAWINGS

Embodiments are now described, by way of non-limiting example, and are illustrated in the following figures, in which:

FIG. 1 is a schematic diagram of an apparatus for processing image data in accordance with an embodiment;

FIG. 2 is a schematic diagram of a method for processing image data according to an embodiment;

FIG. 3 is a schematic diagram of an image analysis model according to an embodiment;

FIG. 4 comprises three schematic illustrations of image token representations in accordance with an embodiment;

FIG. 5 is a schematic diagram of a method for processing image data in accordance with an embodiment;

FIG. 6 is a schematic of an automated report generation method in accordance with an embodiment;

FIG. 7 is a schematic diagram of a method for processing image data according to an embodiment; and

FIG. 8 comprises three medical images with overlaid visual features;

### DETAILED DESCRIPTION

Certain embodiments provide a data processing apparatus configured to train an image analysis model to perform a task relating to input data which includes at least image data, wherein the data processing apparatus comprises processing circuitry configured to:
receive the input data;
generate image tokens for inputting to the image analysis model by applying a visual extractor model that is trained to identify an anatomical region included in the image data which is comprised in the input data and to determine a label relating to a pre-determined sub-task relating to said anatomical region; and
train the image analysis model by inputting at least the image tokens.

Certain embodiments provide a data processing apparatus for applying an image analysis model that is trained to perform a task relating to input data which includes at least image data, the data processing apparatus comprising processing circuitry configured to:
receive the input data associated with a subject;
   generate image tokens for inputting to the image analysis model by applying a visual extractor model that is trained to identify an anatomical region included in the image data which is comprised in the input data and to determine a label relating to a pre-determined sub-task relating to said anatomical region; and
apply the image analysis model to said image tokens, wherein the transformer model performs said task and generates an output relating to the subject.

Certain embodiments provide a method for training an image analysis model to perform a task relating to input data which includes at least image data, the method comprising:
receiving the input data;
generating image tokens for inputting to the image analysis model by applying a visual extractor model that is trained to identify an anatomical region included in the image data which is comprised in the input data and to determine a label relating to a pre-determined sub-task relating to said anatomical region; and
training the image analysis model by inputting the image tokens.

Certain embodiments provide a method for applying an image analysis model that is trained to perform a task relating to input data which includes at least image data, the method comprising:
receiving the input data associated with a subject;
generating image tokens for inputting to the image analysis model by applying a visual extractor model that is trained to identify an anatomical region included in the image data which is comprised in the input data and to determine a label relating to a pre-determined sub-task relating to said anatomical region; and
applying the transformer model to said image tokens, wherein the image analysis model performs said task and generates an output relating to the subject.

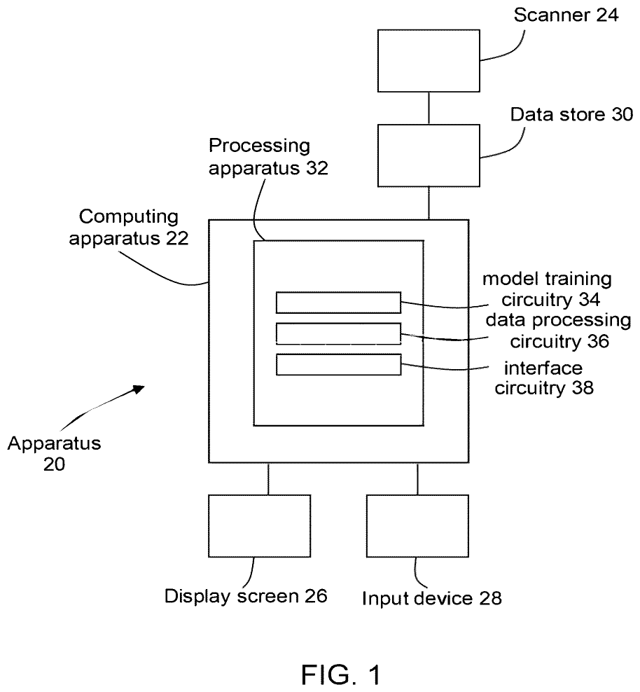

A data processing apparatus 20 according to an embodiment is illustrated schematically in FIG. 1. In the present embodiment, the data processing apparatus 20 is configured to process medical image data. In other embodiments, the data processing apparatus 20 may be configured to process any other appropriate image data.

The data processing apparatus 20 comprises a computing apparatus 22, which in this case is a personal computer (PC) or workstation. The computing apparatus 22 is connected to a display screen 26 or other display device, and an input device or devices 28, such as a computer keyboard and mouse.

The computing apparatus 22 is configured to obtain data sets from a data store 30. At least some of the data obtained from the data store comprises medical imaging data, for instance data obtained using a scanner 24. The medical image data may comprise two-, three- or four-dimensional data in any imaging modality. For example, the scanner 24 may comprise a magnetic resonance (MR or MRI) scanner, CT (computed tomography) scanner, cone-beam CT scanner, X-ray scanner, ultrasound scanner, PET (positron emission tomography) scanner or SPECT (single photon emission computed tomography) scanner.

The medical imaging data may comprise or be associated with additional data, which may for example comprise non-imaging data. The non-imaging data may comprise text data. For example the non-imaging data may comprise a patient history. The non-imaging data may comprise information relating to a scan, for example a reason why the scan was taken. The non-imaging data may comprise a question to be answered. The non-imaging data may comprise structured clinical data. The non-imaging data may comprise genetics data.

The computing apparatus 22 may receive data from one or more further data stores (not shown) instead of or in addition to data store 30. For example, the computing apparatus 22 may receive medical image data from one or more remote data stores (not shown) which may form part of a Picture Archiving and Communication System (PACS) or other information system.

Computing apparatus 22 provides a processing resource for automatically or semi-automatically processing the data. Computing apparatus 22 comprises a processing apparatus 32. The processing apparatus 32 comprises model training circuitry 34 configured to train one or more models, data processing circuitry 36 configured to apply trained model(s) and to perform other processes for example image classification, visual question answering, image captioning and/or automated reporting, and interface circuitry 38 configured to obtain user or other inputs and/or to output results of the data processing.

In the present embodiment, the circuitries 34, 36, 38 are each implemented in computing apparatus 22 by means of a computer program having computer-readable instructions that are executable to perform the method of the embodiment. However, in other embodiments, the various circuitries may be implemented as one or more ASICs (application specific integrated circuits) or FPGAs (field programmable gate arrays).

The computing apparatus 22 also includes a hard drive and other components of a PC including RAM, ROM, a data bus, an operating system including various device drivers, and hardware devices including a graphics card. Such components are not shown in FIG. 1 for clarity.

The data processing apparatus 20 of FIG. 1 is configured to perform methods as illustrated and/or described in the following.

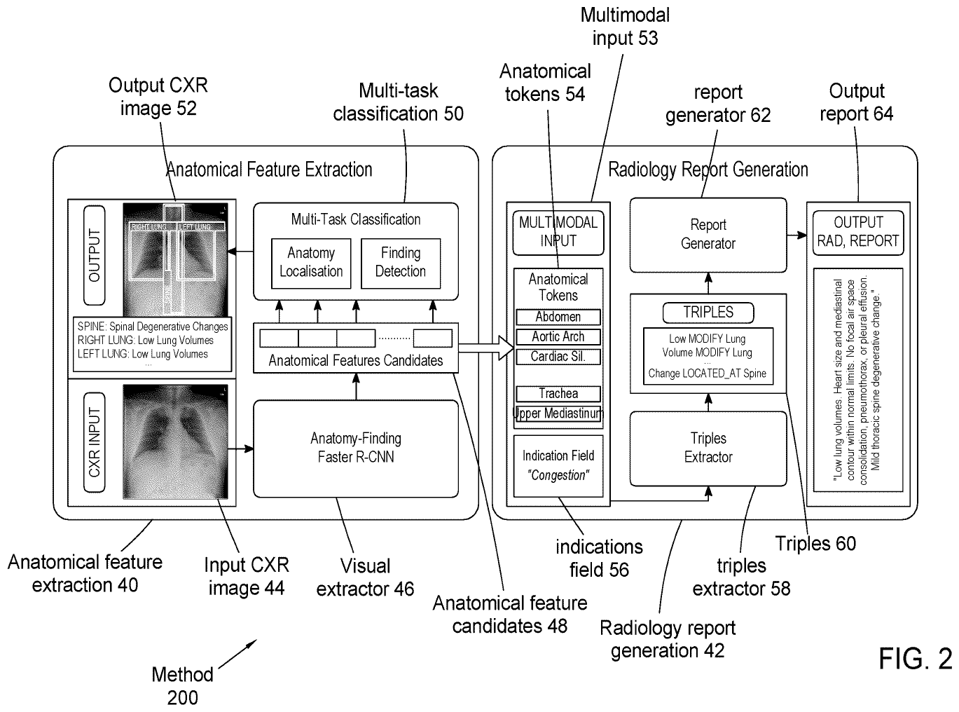

FIG. 2 is a flow chart illustrating in overview a method 200 of processing data, including medical image data, in accordance with an embodiment. In FIG. 2 the method of processing data is shown as integrated with a multimodal automated reporting pipeline for Chest X-Ray (CXR) images. The combined method is shown as comprising two parts, anatomical feature extraction 40 and Radiology report generation 42.

In the anatomical feature extraction 40 part, an input CXR image 44 is provided to a visual extractor 46 for finding anatomical features. The visual extractor 46 may comprise a CNN. In this embodiment, the visual extractor 46 comprises a Faster R-CNN. In other embodiments, the input image may be an image in any other format including MRI and CT scans and may include text.

The visual extractor 46 selects a set of anatomical feature candidates 48 based on the input CXR image 44. The visual extractor 46 is trained to identify one or more of a predetermined set of spatial regions that are associated with particular anatomical features. These may include left upper lung, mediastinum, right apical zone, right atrium and other such relevant anatomical features. The set of anatomical feature candidates 48 comprise one or more anatomical tokens that the visual extractor 46 identifies in the input image and one or more of a plurality of predetermined findings associated with the anatomical feature candidates. The obtaining of such findings may be referred to as sub-task(s).

The extraction of tokens from predetermined sets of spatial regions normalises the semantic structure of the input sequence. By implicitly providing information about the location of each finding to the Transformer model the method leads to more accurate model predictions.

The anatomical feature candidates 48 are provided as input to the radiology report generation part 42 and the multi-task classifier 50. The multi-task classifier 50 and the radiology report generation part 42, together comprise the image analysis model.

The multi-task classifier 50 performs the tasks of anatomy localisation and finding detection. Anatomy localisation comprises the task of predicting the bounding box coordinates of a particular element of anatomy or anatomical feature. In FIG. 2, two-dimensional bounding boxes delineating anatomical features are shown in the output CXR image 52. Finding detection is the task of predicting the findings within each region. The finding may comprise any clinically relevant information about a patient that is identified in a medical image, such as a symptom associated with an anatomical feature or a change in the condition of an anatomical feature. The finding may be an event or change with relevance to radiological examination. The finding may be and improvement or a worsening in the intensity or spatial spread of a pathology.

The multi-task classifier 50 produces an output CXR image 52 in which anatomical tokens may be labelled. The detected anatomical tokens may be labelled visually, as seen in bounding boxes superimposed on the input CXR image 52 in FIG. 2. The features may also be labelled using text also seen superimposed on the input image. The output may be accompanied by text generated by the multi-task classifier 50. In the embodiment illustrated, this text comprises labels of anatomical tokens accompanied by the finding associated with the anatomical feature. The format of the output CXR image 52 is particular to this embodiment. The detected finding and anatomical tokens may be illustrated in a variety of other ways in other embodiments.

The multimodal anatomical feature candidates 48 provided as input to the radiology report generation 42 part comprise one or more anatomical tokens 54 and indications field 56 that correspond to the input CXR image 44. The indication field contains the finding label identified during multi-task classification 50.

The anatomical tokens 54 and the indication field 56 information is passed to the triples extractor 58 which generates triples 60. Triples 60 comprise information that expresses the relation between two entities. In the present embodiment, the entities comprise anatomical features and their associated properties. In other embodiments, the triples 60 may define relationships between other entities. The output CXR image 52 may include localisation/detection predictions on the image resulting from the training tasks, for example bounding box coordinates for each anatomical region plus probability of each finding in that region. The intermediate representations from this network (e.g. Anatomical Feature Extraction) may be used as input to the Radiology Report Generation model, which then produces the output report 64, which is a text report in this embodiment. For example, a report generator 62 uses the multimodal input 53 and the triples 60 to generate an output report. The output report 64 in this embodiment comprises textual information. In other embodiments, the output report 64 may comprise one or more images or a combination of text and images.

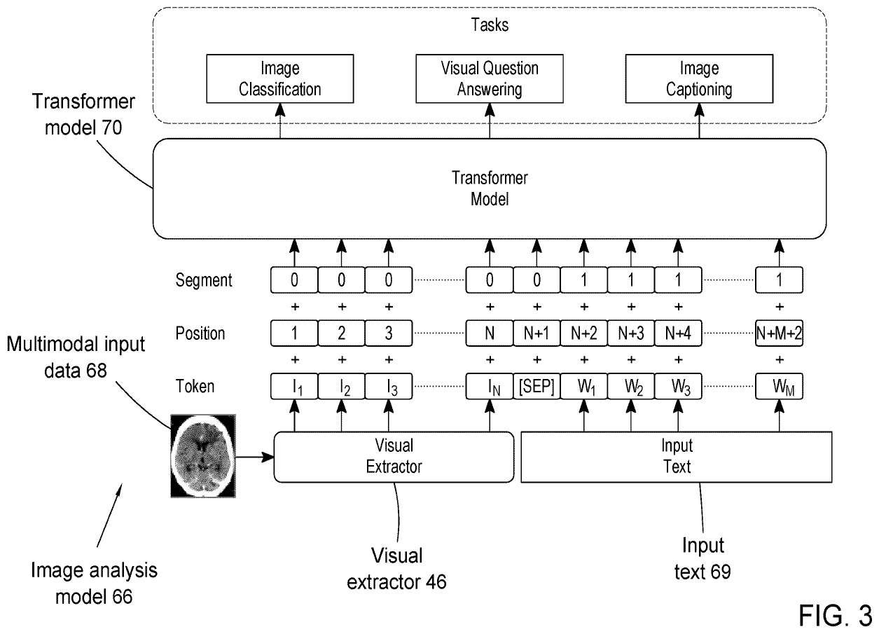

FIG. 3 is a schematic diagram of an image analysis model 66 according to an embodiment. Image analysis models include transformer models which leverage multi-headed attention mechanisms. Other implementations of image analysis models include convolutional neural networks and recurrent neural networks. Transformers are state-of-the-art for Natural Language Processing (NLP) tasks and show increasing promise for imaging tasks.

Inputs to transformers may comprise image tokens, position embeddings and segment embeddings. In FIG. 3, multimodal input data 68 is provided to a visual extractor 46 to obtain image tokens. Position and segment embeddings are obtained from the tokenised inputs. The image tokens may be obtained from a visual extractor 46 wherein the visual extractor may be a residual neural network or similar neural network. Positions embeddings comprise a vector representation of the index of tokens in the input sequence. This allows the image analysis model to access the order of the token embeddings, or the order in which tokens appeared in the input sequence. Segment embeddings comprise a vector representation of the modality of the input and help the model to distinguish between different modes of input, such as image data and text data. In this embodiment the multimodal input data 68 comprises data in visual and textual formats, but in other embodiments, other formats of data may be used. The textual data comprises the input text 69 shown in FIG. 3 separately from the visual data. The vector representations of the input data and the format of the input data described above are provided to the transformer model 70 for anatomy localisation, finding detection and report generation. Tokenisation is performed within the Radiology Report Generator. Each text generation model may have its own corresponding tokeniser.

Examples of imaging tasks using transformers include image classification, image captioning, visual question answering and automated reporting. The use of a transformer architecture allows the concatenation of visual and textual inputs and the use of multimodal inputs. Visual question answering is the task of answering a question wherein the question makes reference to an image and is an example of a multimodal input to the image analysis model. Automated reporting is the task of generating a textual description for an image and may include image captioning.

The Faster R-CNN may output a finding probability (scalar value). The transformer may output a text description of the finding and any relevant details which should be included in a report (e.g. location, severity).

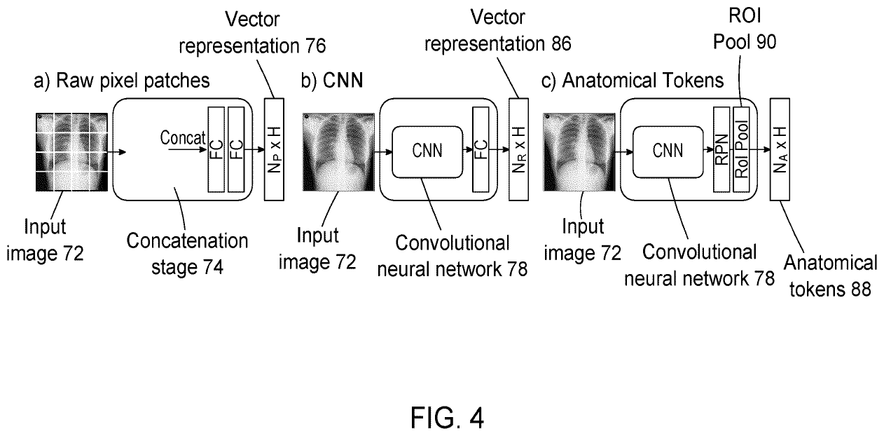

FIG. 4 shows three different formats of image token representations that are typically provided to the image analysis models and the method of their generation. The format of tokens obtained depends on the choice of visual extractor 46.

FIG. 4a illustrates an input image 72 that is divided up into a rectangular or square or any other suitable array of e.g. size M×N wherein each section is referred to as a raw pixel patch. The patches are then concatenated to form a sequence of length Np in the concatenation stage 74, where Np is an integer. The sequence of patches is processed using a stack of Fully Connected Layers (FCL) to obtain a latent vector representation 76 of the input image, of length Np. A fully connected layer produces a representation with the right dimensions for inputting to the Radiology Report Generator model. In variants of the embodiment, this layer may be trained by predicting the class of the image, or by end-to-end training with the Radiology Report Generator model. The CNN model aims to extract the best features from each image for good report generation performance. The representation is representative of the full input image 72.

FIG. 4b illustrates an input image 72 that is processed using a CNN 78 to obtain a feature map of size K×L. The feature map is then flattened and processed by a FCL into Nr individual image embeddings, where Nr is an integer. The representation is representative of the full input image 72.

FIG. 4c illustrates an input image 72 processed using a CNN 78 to obtain one or more anatomical tokens. The image is processed using the CNN 78, a Region Proposal Network (RPN) and a Region of Interest Pooling layer 90 (ROI Pool) to obtain Na anatomical feature embeddings, or anatomical tokens 88, where Na is an integer. The representation contrasts with those in FIGS. 4a and 4b because it represents specific objects in the image rather than the complete image. Object detection is the task of identifying instances of semantic objects in an image, by detecting the boxes coordinates containing them.

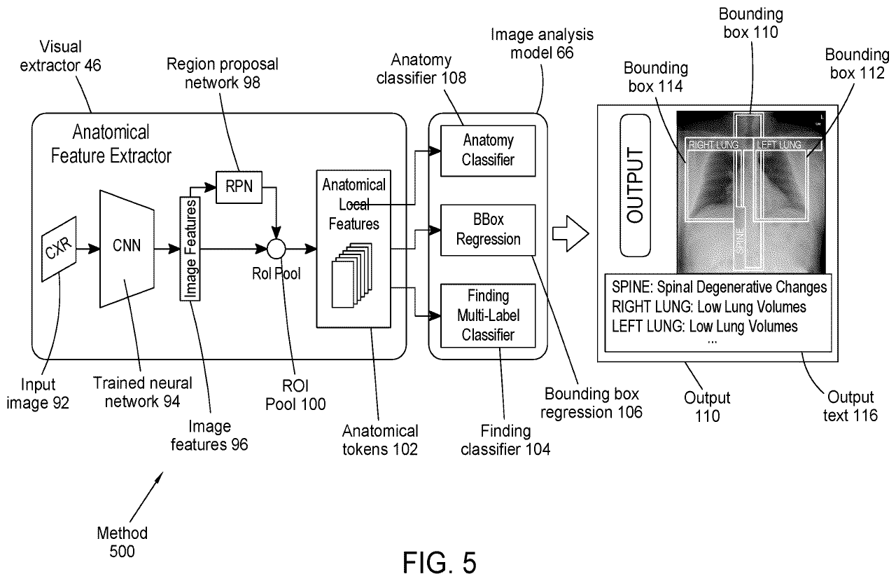

FIG. 5 is a schematic illustration of a method 500 of processing image data in accordance with an embodiment. FIG. 5 shows detail of the visual extractor 46 and image analysis model 66 used to obtain anatomical tokens from visual data according to an embodiment. The input image 92 is provided as input to a trained neural network 94, which may comprise a Faster R-CNN. The trained neural network 94 in this embodiment is trained on the ‘Chest ImaGenome’ dataset to detect 36 anatomical features and 71 findings associated with the anatomical features. The neural network 94 obtains image features 96 from the input image 92. A region proposal network (RPN) 98 is a neural network that processes the image features to propose one or more number of candidates bounding box coordinates for each of the target anatomical regions. The output from the RPN 98 is combined with the image features 96 in the Region of Interest Pooling layer (ROI Pool) 100. The ROI Pool 100 outputs anatomical tokens 102 corresponding to anatomical features present in the input image 92. For each of the candidate bounding boxes proposed by the RPN, the RoI Pooling layer extracts the corresponding region from the Image Features representation and flattens this into a vector representation.

The anatomical tokens 102 are processed by the image analysis model 66, which may comprise a transformer model 70. In this embodiment, the image analysis model 66 performs anatomy classification, bounding box regression and multi-label classification on the anatomical tokens 102. Anatomy classification and multi-label classification have been described in relation to FIG. 2 and the description is not repeated here. Typically, bounding box regressors predict the location of target object classes as a pair of coordinate locations (e.g. top left, bottom right) and they are trained with respect to ground truth bounding boxes. In Faster R-CNN these bounding box predictions are called region proposals. The coordinate predictions may be initialised using fixed anchor boxes.

The image analysis model 66 generates the output 110 which may be multimodal, such as a combination of visual and textual elements as shown in FIG. 5.

In the current embodiment, the output 110 comprises the input image 92 overlaid with bounding boxes 110, 112 and 114. Three bounding boxes 110, 112, 114 are shown for purposes of illustration but there may be a larger number of boxes in practice. However, it is possible to detect just three, or any other desired number of, anatomical regions and not detect others. The bounding boxes delimit the coordinate points in the image that constitute one of a plurality of predetermined anatomical features. The classifications, or labels, of these anatomical features is also shown in text, ‘Right Lung’ for bounding box 114, ‘Spine’ for bounding box 110 and ‘Left Lung’ for bounding box 112. The output 110 further comprises output text 116 which contains classifications/labels of anatomical features and findings associated with the anatomical feature. In output text 116 in FIG. 5, the anatomical features identified in the output 110 are listed in textual format with corresponding findings for the respective anatomical features. The format of output 110 is not limited by this embodiment. Any combination of visual and/or textual information may be used to generate the output 110.

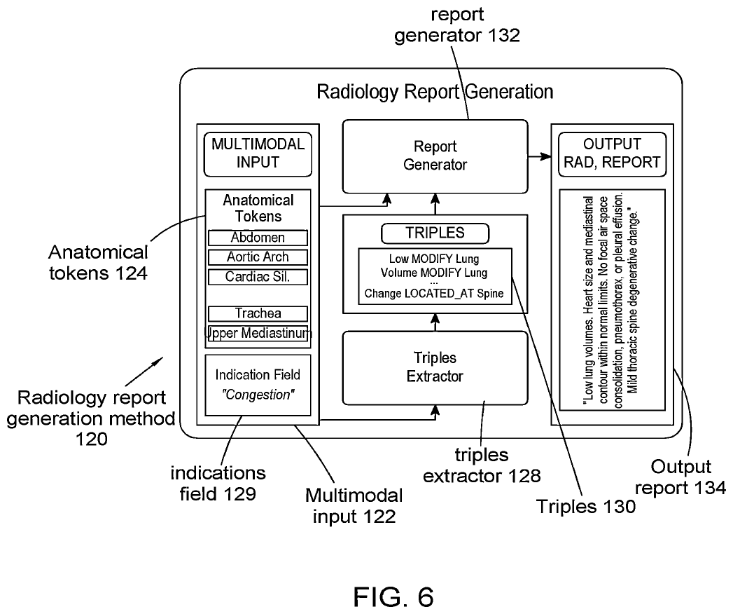

FIG. 6 is a schematic of an automated report generation method in accordance with an embodiment. In this embodiment, the report is a radiology report based in an input chest X-ray image. In other embodiments, the report may be obtained from a different image or medical image and may include text. The multimodal input 122 provided to the radiology report generation method 120 comprises one or more anatomical tokens 124 obtained by the visual extractor and one or more indication fields 129 which are the findings associated with the anatomical tokens 124. At each step we consider a Transformer Encoder-Decoder backbone. It is a feature of various embodiments that neural networks are used at each step in the report generation process, these steps may be handled by the or a transformer, and the report generator and triples extractor in the present embodiment are both individual transformers. In the present embodiment, there are two transformers, namely the Triples Extractor and Report Generator, although any suitable other model architectures may be used in other embodiments.

The first step of the method is triples extraction, carried out by triples extractor 128. In this step, a set of structured information is obtained from a CXR. The information is expressed as triples 130 and follows a format ‘entity 1’, ‘relation’, ‘entity2’. In the present embodiment, the entities comprise anatomical features and their associated properties. In other embodiments, the triples 130 may define relationships between other entities. A report generator 132 uses the multimodal input 122 and the triples 130 to generate an output report 134. The output report 134 in this embodiment comprises textual information. In other embodiments, the output report 134 may comprise one or more images or a combination of text and images.

During the training phase of the report generator 132, in this embodiment we apply masking of the ground-truth triples, where a percentage of the ground-truth triples is removed from the input sequence, to encourage the model to attend the visual embeddings.

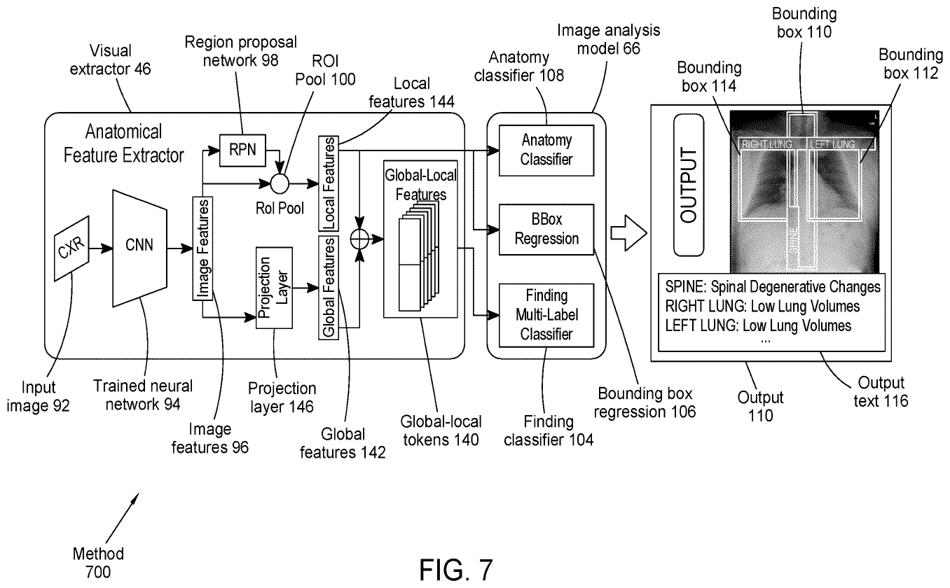

FIG. 7 is a schematic diagram of an apparatus according to an embodiment. This embodiment comprises elements in addition to the elements of the embodiment in FIG. 2. The description of this embodiment will focus on the added elements and previously described elements will not be described in detail. For the purposes of the discussion below, local features comprise feature vector representations of regions within the full input image while global features comprise feature vector representations of the full input image. In this embodiment, the image features 96 are processed using a projection layer 146 to obtain global features 142 which are representative of the full input image 92. Local features may be used instead of global features in some embodiments. Image features are processed using a RPN 98 and ROI Pool 100 to obtain local features 144 which are representative of one of a plurality of predetermined anatomical features. The local features 144 are provided to the image analysis model 66 as inputs for the processes of anatomy classification 108 and bounding box regression 106. The local features 144 and the global features 142 are concatenated to form global-local tokens 140 which are provided to the image analysis model 66 for the purpose of multi-label classification of findings. The image analysis model 66 generates an output 110 which is in the format of a radiology report containing image data and text data. The use of global features 142 in combination with local features 144 is beneficial where a specific finding spans multiple anatomical regions, or equivalently, is associated with multiple anatomical tokens.

In another embodiment, which may be provided separately, the report generator model is trained using finding labels obtained from the visual extractor 46. Clusters of tokens which relate to findings in a given output sentence or sentences can then be masked. The sentence or sentences can hence be included or excluded from the generated report. This is equivalent to providing counterfactual statements during training and is beneficial for the accuracy and interpretability of the generated report. Masking provides stronger supervision between input tokens and output sentences and improves accuracy by reducing hallucinations. A tighter information flow from spatially corresponding input tokens to output sentences improves the interpretability of the generated report.

Table 1 shows qualitative results for a partial reports generation process performed according to an embodiment. From left to right the columns in Table 1 represent the subset of anatomical regions that are desired to be reported, the ground truth partial reports, the reports generated by the baseline (without adding prior scans and sentence-anatomy training) and finally those generated by the method of the embodiment. Hallucinations produced by the baseline method are highlighted in the third column.

TABLE 1

| Anat. Regions | Ground Truth | Baseline | Ours |
|---|---|---|---|
| spine | Moderate anterior | The heart is at the upper limits of | Mild degenerative |
| | osteophytes along the | normal size. The aortic arch | changes are |
| | lower thoracic spine | is calcified. The mediastinal and hilar | similar along the |
| | appear unchanged. | contours appear | thoracic |
| | | unchanged. There is no pleural | spine. |
| | | effusion or pneumothorax. | |
| | | The lungs appear clear. | |
| cardiac | Moderate to severe | Moderate enlargement of the cardiac | Moderate to severe |
| silhouette | enlargement of the | silhouette is | cardiomegaly is |
| | cardiac silhouette is | re-demonstrated. Mediastinal and hilar | re-demonstrated. |
| | unchanged. | contours are | |
| | | unchanged. Pulmonary vasculature is | |
| | | not engorged. No focal | |
| abdomen, | The nasogastric tube has | The heart size is normal. The hilar and | The nasogastric |
| cardiac | been removed. The heart | mediastinal contours are normal. There | tube has |
| silhouette, | and mediastinum are | has been interval resolution of the | been removed. The |
| mediastinum, | within normal | previously seen small left-sided | cardiomediastinal |
| left lung, | There are areas of streaky | Lung volumes are low. Linear opacities in | There is |
| left lower lung | atelectasis at the | the bilateral lower lungs | pulmonary |
| zone | bilateral lung bases. There | are most consistent with subsegmental | vascular |
| left costophrenic | are persistent | atelectasis. There is no | congestion and |
| angle, | prominent interstitial | focal consolidation pleural effusion or | mild interstitial |
| left hilar | markings which suggest | pneumothorax. The | pulmonary |
| structures, | chronic interstitial | cardiomediastinal silhouette is | edema. Linear |
| right lung, | abnormality versus mild | unchanged. | bibasilar opacities |
| right lower lung | interstitial edema. The lungs | | are most |
| zone, | remain | | consistent with |
| right | hyperinflated. There is no | | atelectasis. There |
| costophrenic | pleural effusion or | | is no pleural |
| angle, | pneumothorax. No focal | | effusion or |
| right hilar | consolidation is | | pneumothorax. |
| structures | seen. | | |

Table 1 also appears in Controllable Chest X-Ray Report Generation from Longitudinal Representations, arXiv:2310.05881, Dalla Serra et al, the contents of which are hereby incorporated by reference in their entirety. The contents of Finding-Aware Anatomical Tokens for Chest X-Ray Automated Reporting, arXiv:2308.15961, Dalla Serra et al are also hereby incorporated by reference in their entirety.

In another embodiment, that may be provided separately, spatial hierarchical relationships are defined between tokens to allow masking of different hierarchical layers during training. In one embodiment, this comprises masking out the left lung but retaining lower, mid and upper left lung tokens. This forces the image analysis model 66 to pay attention to all tokens, even when there is redundancy in input tokens, rather than learning from a subset of tokens.

Masking may also be achieved by arranging anatomical regions in generational layers in an ontology that correspond to relationships between the regions in each layer. Training the image analysis model for this embodiment comprises masking out a generational layer in the ontology.

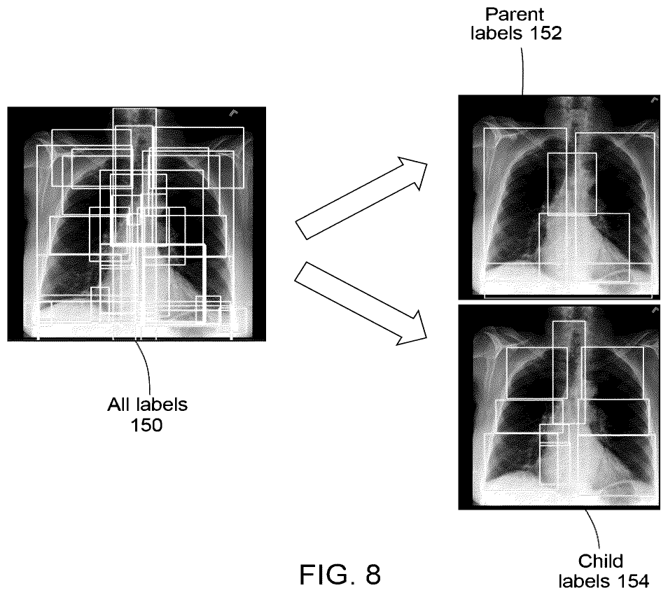

FIG. 8 shows a CXR scan overlaid with the complete set of predetermined anatomical tokens and their associated bounding boxes labelled ‘all labels’ 150. The labels associated with the anatomical tokens and bounding boxes in ‘all labels’ 150 comprise abdomen, aortic arch, cardiac silhouette, carina, cavoatrial junction, descending aorta, left apical zone, left cardiac silhouette, left cardiophrenic angle, left clavicle, left costophrenic angle, left hemidiaphragm, left hilar structures, left lower lung zone, left lung, left mid lung zone, left upper abdomen, left upper lung zone, mediastinum, right apical zone, right atrium, right cardiac silhouette, right cardiophrenic angle, right clavicle, right costophrenic angle, right hemidiaphragm, right hilar structures, right lower lung zone, right lung, right mid lung zone, right upper abdomen, right upper lung zone, spine, svc, trachea and upper mediastinum.

FIG. 8 also shows a ‘parent labels’ 152 CXR scan showing a subset of the labels from ‘all labels’ and includes left lung, right lung, upper mediastinum, cardiac silhouette, and abdomen. A spatial hierarchical relationship may be defined between the labels, or tokens in ‘all labels’ 150 and ‘parent labels’ 152 and used for the purpose of masking out hierarchical layers during training. The spatial relationships that may be of interest may be between ‘parent’ and ‘child’ labels in this example. Each of these groups may be drawn from the ‘all labels’ pool.

Similarly, FIG. 8 also shows a ‘child labels’ 154 CXR scan showing a subset of the labels from ‘all labels’ and includes left mid lung zone, left lower lung zone, right atrium, cavoatrial junction, right mid lung zone, right upper lung zone, right lower lung zone, left upper lung zone and trachea. A spatial hierarchical relationship may be defined between the labels, or tokens in ‘all labels’ 150 and ‘child labels’ 154 and used for the purpose of masking out hierarchical layers during training. Similarly, a spatial hierarchical relationship may be defined between the labels, or tokens in ‘parent labels’ 152 and ‘child labels’ 154 and used for the purpose of masking out hierarchical layers during training.

In another embodiment, which may be provided separately, token masking and token exclusion can be used at the time of deployment to control the predictions of the model. For example, the image may be input to the system as usual, and then tokens corresponding to any regions not desired to be reported on may be masked out, in order to obtain a desired output report (e.g. describing only findings in unmasked regions). This has particular applicability when a report on a specific part of the anatomy is required, such as heart, lungs or skeleton in a chest scan. It can also be beneficial for image captioning, automated report generation and when performing visual question answering for specific parts of the anatomy.

In another embodiment, which may be provided separately, tokens can be paired for sequential scans to aid in comparison. This can be helpful when comparing a scan with a follow-up scan and can be achieved by pairing corresponding anatomical tokens at the input. The finding in case of token-pairing may be a change of an attribute of a finding between the prior scan and the current scan, or the absence of a change of said attribute. The obtaining of such findings may be referred to as a sub-task The pairing may, for example, comprise a concatenation. Any suitable other method may be used, but concatenation in some examples can have an advantage that corresponding image features in corresponding spatial locations are aligned, making them easy for the transformer to compare during processing (e.g. acts as inductive bias).

Experimentally obtained results of an embodiment of the invention are now described. Table 2 reports a comparison of results for anatomy localisation and finding detection for three different embodiments of the Faster R-CNN. The first of these uses anatomy localisation only. The second uses anatomy localisation and finding detection. The third uses anatomy localisation, finding detection and concatenates global and local features to obtain input tokens for the image analysis model. In Table 1, ‘mAP@0.5’ means ‘Average Precision, with positive detection at Intersection over Union>0.5’ and AUROC is the macro average of the area under the receiver operatic characteristic for each finding at each anatomical region. The results are based on the publically available Chest ImaGenome dataset. The obtaining of such findings may be referred to as sub-task(s).

TABLE 2

| Anatomy | Finding | G-L Feat. | AUROC | mAP@0.5 |
|---|---|---|---|---|
| ✓ | | | — | 0.938 |
| ✓ | ✓ | | 0.863 | 0.918 |
| ✓ | ✓ | ✓ | 0.874 | 0.917 |

Further implementation details of embodiments used to obtain the results are now provided.

For each CXR, anatomy localisation is framed as a general object detection task, where the Faster R-CNN framework was employed to compute the coordinates of the bounding boxes and the anatomical labels assigned to each of them. More specifically, for each bounding box candidate generated from the Region Proposal Network (RPN)—corresponding to the top-left and bottom-right coordinates—and the corresponding fixed-length vector (local features), extracted from the Region of Interest (RoI) pooling layer, is classified to which anatomical region the RoI corresponds.

In parallel to predicting the bounding box coordinates and the anatomical labels, an additional multi-label classification head is included that detects a set of findings for each anatomical region, which may be referred to as a sub-task. Additionally to the original Faster R-CNN implementation, a set of global features is first extracted. We consider as image features the output of the CNN backbone, composed by a ResNet-50 and a Feature Pyramid Network (FPN). Specifically, the four multi-scale feature maps from the FPN are concatenated along the channel dimension. Global features global features g=conv2D(m)∈R^{d}, with conv2D representing a 2D convolutional layer, with kernel size (K×K) input channel equal to Z and output channel equal to the same dimension d of the local feature vectors lk. For each RoI k, we concatenate the corresponding local features lk and the CXR global features g, obtaining glk=[g, lk]∈R^{2d}, which is then passed as input to the finding multi-label classifier. The global feature vector is provided to the classifier as additional image-level context and contributes positively whenever a specific finding spans multiple anatomical regions (e.g., tubes) or whenever the bounding box is not properly localised. For each CXR scan, we refer to the set of concatenated global and local features as gI∈RN×2d, and these correspond to the input visual sequence of the proposed automated reporting method.

During training, for example in relation to sub-tasks, a multi-task loss is used comprising three terms: anatomy classification loss, finding multi-label classification loss and box regression loss. Formally, for each predicted bounding box, this is computed as

$$∠ = ∠ anat + {∠}_{box} + λ ∠find ,$$

Where Lanat and Lbox correspond to the classification loss and the bounding box regression loss, respectively. While the finding multi-label classification lossLfind corresponds to a binary cross-entropy loss with class weighting wj=(1/vj)^{0.25}, where vj is the frequency of the finding j over the training set; and A is a balancing hyper-parameter set to A=10².

Given a set of CXR images I={Ip}Pp=1, we aim to automatically generate the radiology reports R={Rp}Pp=1. A two-stage approach for automated reporting on CXR images can be used. The first step is defined as Triples Extraction, which consists in extracting structured information from a CXR image Iₚ in the form of triples Trpp={Trppl}_{LI=1}. The second step, or Report Generation step, consists of generating the radiology report Rₚ.

At each step, a multimodal encoder-decoder Transformer (fTE and fRG) is employed and the two steps are treated as sequence-to-sequence tasks. Formally, given the set of global-local features gIₚ associated with a CXR and the indication field Iₚ, we train the first step, or Triples Extraction, to perform Trpp=fTE(gIp, Indₚ), where Trpp corresponds to the target set of triples. The second step, or Report Generation, is defined as Rₚ=fRG(gIp, Indₚ, Trpₚ), where the report Rₚ is generated given gIp, Indₚ, and the set of triples Trpₚ extracted in step 1. During the training phase of step 2, a masking procedure of the ground-truth triples is used, where a percentage of the ground-truth triples is removed from the input sequence, to encourage the model to attend the visual embeddings.

The input sequence consists of the concatenation of the different input modalities, and the input embeddings correspond to the sum of the token embeddings (textual and visual), the positional embeddings and the segment embeddings (to discriminate between the two modalities).

Experiments whose results are represented in the tables above were based on two open-source CXR datasets: Chest ImaGenome and MIMIC-CXR. The Chest ImaGenome dataset is derived from the MIMIC-CXR and introduces extra automatically-extracted annotations adopting an atlas-based pipeline to detect the anatomical bounding box regions from 242,072 anteroposterior (AP) and posteroanterior (PA) CXRs; and a rule-based natural language processing approach to extract the findings related to each region, based on the associated radiology reports. We aim to localise 36 anatomical regions and detect 71 findings.

The MIMIC-CXR dataset comprises the CXR-report pairs, and it is used for report generation. We only consider the Finding Section of each report as the target report, following previous works; this section contains detailed information about the findings appearing in a CXR. Furthermore, we extract the Indication Field from each report and use it as additional context at each step of our report generation pipeline. This section is available at imaging time and contains some relevant medical history of the patient and/or the reason why the scan was taken.

We annotate the set of ground-truth triples associated with each image-report pair, following a semi-automated pipeline as described in [6]. The ground-truth triples serve to supervise the first step of the automated reporting pipeline.

For the experiments, the same train/validation/test split as proposed in the Chest ImaGenome dataset was considered. The images are resized and cropped to a resolution of 512×512, and the aspect ratio is maintained.

Faster R-CNN. The fasterrcnn resnet50 fpn v2 implementation available in torchvision is adapted, as described in Section 2.1, and it is trained to localise the 36 anatomical regions and detect the presence or absence of the 71 findings within each region. We train the model for 25 epochs and the learning rate set to 10³. At inference time, for each CXR, we consider the predicted anatomical region with the highest confidence score, and we extract the 2048-dimensional local-global feature vectors. Whenever an anatomical region is not detected, the local features correspond to a 1024-dimensional zero vector.

Two-Step Pipeline. At each step, a vanilla Transformer encoder-decoder backbone is used. Both the encoder and the decoder consist of 3 attention layers, each composed of 8 heads and 512 hidden units. All the parameters are randomly initialised. Step 1 is trained for 40 epochs, with the learning rate set to 10⁻⁴. Step 2 is trained for 20 epochs, with the same learning rate as step 1. During training, 50% of the ground-truth triples were masked out (this percentage was empirically found to perform best), while during inference we use the triples extracted at step 1.

Faster R-CNN. The proposed Faster R-CNN has been compared with two baselines: a standard Faster R-CNN trained for anatomy localisation only—to assess whether introducing the finding multi-label classification head degrades the localisation performances; and a multi-task Faster R-CNN without the global features concatenation—to evaluate the benefit of introducing some image-level context for finding detection.

Automated Reporting. The two-step approach has been compared with a one-step baseline, which does not perform the intermediate triples extraction step. The effect of adopting different visual representations: CNN and bounding boxes (BBox) extracted with different configurations of Faster R-CNN has been studied.

The anatomy localisation performances of the Faster R-CNN is evaluated by computing the mean Average Precision (mAP@0.5), with positive detections when the Intersection over Union score between the predicted bounding boxes and the ground truth is above 0.5. The finding detection performances are computed by computing the average of the Area Under the Receiver Operating Characteristic (AUROC) for each finding at each anatomical region.

To assess the quality of the report generation metrics the Natural Language Generation (NLG) metrics—BLEU, ROUGE and METEOR—are computed as well as the Clinical Efficiency (CE) metrics, derived by applying the CheXpert labeller on the ground-truth and the generated reports—to extract 14 findings—and by computing the F1, precision and recall scores.

The proposed solution has the advantage of having more interpretable feature representations, since each visual token embedding corresponds to a specific anatomical location.

This allows for more control over the generated output. In some examples, we can mask out an anatomical region and the resulting generated report does not describe the findings appearing in that specific region.

The contents of Dalla Serra, F., Wang, C., Deligianni, F., Dalton, J. and O'Neil, A. (2023) Finding-Aware Anatomical Tokens for Chest X-Ray Automated Reporting. In: MLMI 2023, Vancouver, Canada, 8 Oct. 2023, are hereby incorporated by reference in their entirety. The contents of Controllable Chest X-Ray Report Generation from Longitudinal Representations, arXiv:2310.05881, Dalla Serra et al, are also hereby incorporated by reference in their entirety. The contents of Finding-Aware Anatomical Tokens for Chest X-Ray Automated Reporting, arXiv:2308.15961, Dalla Serra et al are also hereby incorporated by reference in their entirety.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Whilst certain embodiments are described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms and modifications as would fall within the scope of the invention.

1. A data processing apparatus configured to train an image analysis model to perform a task relating to input data which includes at least image data, wherein the data processing apparatus comprises processing circuitry configured to:
receive the input data;
generate image tokens for inputting to the image analysis model by applying a visual extractor model that is trained to identify an anatomical region included in the image data which is comprised in the input data and to determine a label relating to a pre-determined sub-task relating to said anatomical region; and
train the image analysis model by inputting at least the image tokens.

2. A data processing apparatus according to claim 1, wherein the task for which the image analysis model is trained comprises generation of a text report.

3. A data processing apparatus according to claim 1, wherein the task for which the image analysis model is trained comprises at least one of: image classification, visual question answering, image captioning, automated reporting.

4. A data processing apparatus according to claim 1, wherein at least one of:
the image analysis model comprises a transformer model; or
the visual extractor model comprises a Faster R-CNN (Region-based convolutional neural network) model.

5. A data processing apparatus according to claim 1, wherein the input data is multi-modal data, and wherein the visual extractor is applied to the multi-modal data.

6. A data processing apparatus according to claim 1, wherein the input data further comprises text data, wherein the image analysis model is applied to the text data.

7. A data processing apparatus according to claim 6, wherein the text data comprises at least one of: patient history data, scan information, information relating to a question to be answered, information relating to the task to be performed, a previous report, a previous radiology report.

8. A data processing apparatus according to claim 1, wherein the predetermined sub-task is a task for obtaining a finding in respect of the anatomical region.

9. A data processing apparatus according to claim 1, wherein the visual extractor model identifies a plurality of anatomical regions.

10. A data processing apparatus according to claim 9, wherein the plurality of anatomical regions are of different generational layers of an ontology, and wherein the training of the image analysis model comprises masking out at least one generational layer of the ontology.

11. A data processing apparatus according to claim 1, wherein the generating of the image tokens comprises concatenating a feature representation of the anatomical region with a global image feature representation.

12. A data processing apparatus according to claim 1, wherein the visual extractor model determines a label for the pre-determined sub-task for each of a cluster of anatomical regions, and wherein the training of the image analysis model comprises masking out the cluster of anatomical regions relating to said pre-determined sub-task.

13. A data processing apparatus according to claim 1, wherein the visual extractor model determines a label for the pre-determined sub-task for each of a plurality of anatomical regions, wherein the training of the image analysis model further comprises inputting ground truth data comprising results of the task to be performed, the results comprising text data comprising a plurality of sentences, and wherein the training of the image analysis model further comprises deleting at least one sentence of the plurality of sentences relating to said pre-determined sub-task and masking out a cluster of anatomical regions corresponding to said deleted at least one sentence.

14. A data processing apparatus according to claim 1, wherein the image data comprises data from two scans of the subject comprising a current scan and a prior scan, and wherein corresponding image tokens from the current scan and prior scan are paired when inputting the image tokens to the image analysis model.

15. A data processing apparatus according to claim 1, wherein the image data comprises data from two scans of the subject comprising a current scan and a prior scan, and wherein the pre-determined sub-task is to predict a change of an attribute of a finding between the prior scan and the current scan, or the absence of a change of said attribute.

16. A method for training an image analysis model to perform a task relating to input data which includes at least image data, the method comprising:
receiving the input data data;
generating image tokens for inputting to the image analysis model by applying a visual extractor model that is trained to identify an anatomical region included in the image data which is comprised in the input data and to determine a label relating to a pre-determined sub-task relating to said anatomical region; and
training the image analysis model by inputting the image tokens.

17. A data processing apparatus for applying an image analysis model that is trained to perform a task relating to input data which includes at least image data, the data processing apparatus comprising processing circuitry configured to:
receive the input data associated with a subject;
generate image tokens for inputting to the image analysis model by applying a visual extractor model that is trained to identify an anatomical region included in the image data which is comprised in the input data and to determine a label relating to a pre-determined sub-task relating to said anatomical region; and
apply the image analysis model to said image tokens, wherein the transformer model performs said task and generates an output relating to the subject.

18. A data processing apparatus according to claim 16, wherein the visual extractor model determines a label for the pre-determined sub-task for each of a plurality of anatomical regions, and wherein the processing circuitry is further configured to receive an input from a user that is indicative of a selection of a sub-set of the plurality of anatomical regions, and to limit the image tokens that are used by the image analysis model in accordance with the selection.

19. A data processing apparatus according to claim 17, wherein the visual extractor model determines a label for the pre-determined sub-task for each of a plurality of anatomical regions, wherein the task comprises visual question answering, and wherein the processing circuitry is further configured to receive a selection of a sub-set of anatomical regions from a user and to perform the task with reference to said sub-set of anatomical regions.

20. A method for applying an image analysis model that is trained to perform a task relating to input data which includes at least image data, the method comprising:
receiving the input data associated with a subject;
generating image tokens for inputting to the image analysis model by applying a visual extractor model that is trained to identify an anatomical region included in the image data which is comprised in the input data and to determine a label relating to a pre-determined sub-task relating to said anatomical region; and
applying the transformer model to said image tokens, wherein the image analysis model performs said task and generates an output relating to the subject.
